(19) United States
(12) Patent Application Publication
(10) Pub. No.: US 2024/0420118 A1
(43) Pub. Date: Dec. 19, 2024

(54) Secure Key Management for Blockchain Transactions

(71) Applicant: Shinami Inc., San Francisco, CA (US)

(72) Inventor: Hao Xia, Dublin, CA (US)

(21) Appl. No.: 18/210,241

(22) Filed: Jun. 15, 2023

(51) Int. Cl. G06Q 20/36; G06Q 20/38

(52) U.S. Cl. CPC G06Q 20/3674; G06Q 20/3829

(57) ABSTRACT

In one embodiment, a method includes receiving, at a stateless key service and from an application associated with a particular user, a user password specific to a particular user/application combination. The method further includes receiving, at the stateless key service and from a wallet service, a wallet salt associated with the user/application combination. The method includes generating, by the stateless key service, an encryption key specific to the user/application combination, based on the user password and the wallet salt. The method includes receiving, at the stateless key service and from the wallet service, an encrypted wallet key associated with the user/application combination; and generating, by the stateless key service, a wallet key specific to the user/application combination, based on the encrypted wallet key and the encryption key. The method includes signing, at the stateless key service, a blockchain transaction using the wallet key.

### TECHNICAL FIELD

This application generally relates to a system and methods for secure key management for blockchain transactions.

### BACKGROUND

A blockchain is an electronically recorded, distributed ledger. Each block in the ledger records some information (e.g., information about one or more transactions), and each transaction is associated with an address to identify that block's location in the blockchain. The records in a blockchain are secure in that once made, a block and its associated information cannot be altered. This structural feature of a blockchain increases the reliability of the recorded information and builds trust among blockchain users that recorded information is accurate. A blockchain can be decentralized, in that the data identifying the blocks making up the blockchain is not stored centrally, and therefore no one entity has control over the blockchain's description. Instead, every node in a decentralized blockchain system has a copy of the blockchain, and some amount of consensus among nodes is required to validate the blockchain's records and add new blocks to a blockchain.

The information in a blockchain can be any type of information. For example, the information may identify the owner of a physical asset or may reflect an agreement, such as a contract, between two or more parties. As another example, the information may identify an owner of, or otherwise provide access to, digital assets, such as cryptocurrency, a non-fungible token, etc.

Information, such as transaction information, in a blockchain can be associated with two types of keys. First, a public key can be used to send assets to a particular entity (which may be a person, a business, etc.) and may be used to associate a recorded transaction with a particular entity (without necessarily revealing the real-world identity of that entity), but the public key does not permit withdrawal of assets identified in a block or otherwise permit the assets identified in the block to be used in another transaction on the blockchain. In contrast, a private key allows access to one or more assets identified in a block, for example access to use those assets in subsequent transactions on the blockchain. In other words, the private key is associated with the ownership of an asset identified by a block in the blockchain. A blockchain wallet (which may be provided by software, hardware, or a combination thereof) can be used to store public keys and private keys, and may be used as an interface to assets on a blockchain. For example, if a user wishes to engage in a transaction regarding one of their assets identified in a block, then the user needs to sign the transaction using their private key, and a wallet can facilitate this signing process.

### BRIEF DESCRIPTION OF THE DRAWINGS

FIG. 1 illustrates an example method of securely managing users' private keys.

FIG. 2 illustrates an example architecture and functional diagram of the example method of FIG. 1.

FIG. 3 illustrates an example architecture and implementation for creating an encrypted wallet key and a wallet salt.

FIG. 4 illustrates an example flow diagram for an example implementation of the example method of FIG. 1.

FIG. 5 illustrates an example flow diagram for creating a wallet on behalf of a user/application combination.

FIG. 6 illustrates an example implementation of an architecture that provides additional blockchain services to an application developer.

FIG. 7 illustrates an example computing system.

### DESCRIPTION OF EXAMPLE EMBODIMENTS

In the blockchain context, a private key is a password that corresponds to ownership of assets identified by, and/or stored by, a block on a blockchain. Private keys provide security by limiting access to owners. A user can locally store a private key on, e.g., a specific device that is accessible only by the user. Some applications provide key services related to password management. For example, a wallet may provide access to a private key through a seed phrase, which may be a 12-word or 24-word string.

In some ways, a private key operates as an entity, in that ownership of assets and the ability to transact with those assets on a blockchain are associated with, and controlled by, a particular private key. If an owner of a private key loses their key (or their seed phrase, if that service is provided), then the corresponding assets are permanently inaccessible; no back-up key or key-recall or key-reset mechanism exists to enable alternative access to the assets associated with that key. For example, if the user loses the one device that stores their private key or that device crashes, then the user permanently loses access to the private key. Simply remembering a private key is typically not a feasible option given the randomness and length of the key. For example, a Bitcoin private key is a random string of 64-alphanumeric characters. Users therefore are typically faced with conflicting goals for security and access: maximize security by limiting access to a private key, for example by not sharing the private key with any other entity and storing the key in only place, which minimizes access in case the private key is lost; or maximize access by sharing the private key with other entities and/or storing the key in multiple locations, which minimizes security, e.g., because other entities then have ownership permissions regarding the corresponding assets. If a user controls multiple private keys, for example different keys associated with different business or for different purposes, this balance between security and usability becomes increasingly pronounced.

Some applications that use blockchain technology may facilitate the management of private keys for a user by creating a wallet on behalf of that user. The user then interfaces with the application to execute some transaction on the blockchain, and the application takes the user's input and facilitates the transaction using the wallet created on behalf of the user, which stores the private keys for that user. The application can also provide enhanced wallet-related services to the user. For example, a user may sign into the application using a traditional password (e.g., username and password combination), and that one application password may provide access to the user's n blockchain private keys. In addition, the application password may be reset or recovered, functionality that is unavailable for blockchain private keys. However, this approach (i.e., having an application-managed wallet), while providing enhanced usability, creates security issues. For example, private keys will be centralized with the entity (e.g., the application developer) that hosts the application data. Therefore, an entity that hacks the application developer can access private keys for many users, creating an attractive hacking target and increasing the security risks to users' private keys.

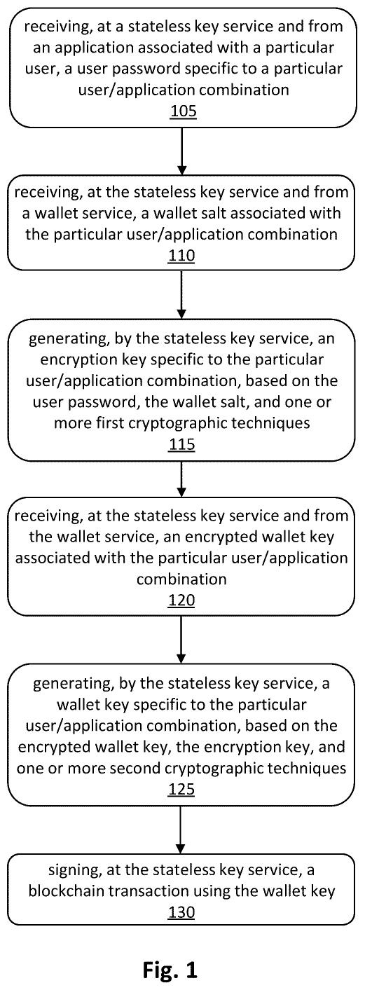

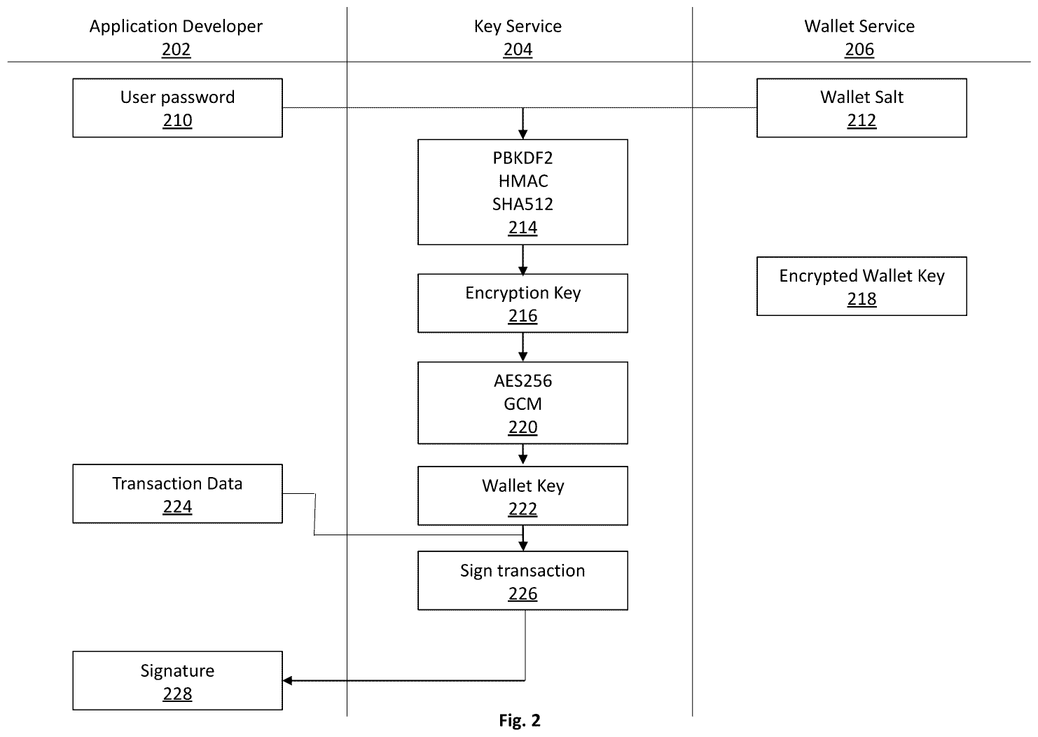

FIG. 1 illustrates an example method of securely managing users' private keys. FIG. 2 illustrates an example architecture and functional diagram of the example method of FIG. 1.

Step 105 of the example method of FIG. 1 includes receiving, at a stateless key service and from an application associated with a particular user, a user password specific to a particular user/application combination. In particular embodiments, the user password is a password (e.g., an alphanumeric string) created by the user and associated with the application. For example, the password may be used to sign in to the application or to the wallet interface used by the application. In particular embodiments, a user can change or recover this user password, in contrast to a private key. In particular embodiments, a user password may be based on or derived from the user's biometric data, such as a fingerprint or facial features specific to the user; this disclosure contemplates that “user password” as used in step 105 refers to any suitable secure credentials specific to the user/application combination, and is not limited to strings created by the user. In particular embodiments, receiving a user password in step 105 includes receiving a representation of that user password (e.g., a hash of that password).

In particular embodiments, step 105 includes receiving the user password from a client computing device (e.g., a smartphone, a PC, a smartwatch, etc.) executing the application. In particular embodiments, step 105 includes receiving the user password from a back-end computing device (e.g., a server device) associated with the application, such as for example a server device managed by an application developer or other manager of the application's backend data. FIG. 2 illustrates an example in which key service 204 receives a user password from application developer 202, such as from a server device managed by application developer 202. As illustrated in FIG. 2, transmission of data to or from an application described herein includes transmission of data to or from a back-end server hosting application-related data, e.g., a server device hosted by the application developer.

In particular embodiments, as in the example method of FIG. 1, key service 204 is a stateless key service, meaning that it does not permanently maintain the information it receives or processes. For example, key service 204 may be a server device that, for the purposes of executing the method of FIG. 1, uses only one or more processors and one or more temporary computer memory components, e.g., volatile memory such as random-access memory (RAM), to process and store information used to generate a wallet key and sign a blockchain transaction.

A blockchain wallet may be integrated with an application in order to provide access to blockchain transactions in association with the application. For example, a financial management application, such as a stock-trading application, may use a blockchain wallet to pay for stock transactions executed in the application. As another example, a gaming application may use a blockchain wallet to facilitate in-game purchases. As another example, an application may use a blockchain wallet to enable the user to electronically sign contracts or approve other agreements or transactions recorded on the blockchain. Embodiments of this disclosure provide a wallet service that allows an application developer to integrate a blockchain wallet with the application so that a user does not need to interface with a third-party wallet or wallet application in order to facilitate transactions within the developer's application, improving user experience and engagement and simplifying transaction flows within the developer application. In addition, a wallet service may free an application developer from having to directly implement wallet functionality within the application.

Step 110 of the example method of FIG. 1 includes receiving, at the stateless key service and from a wallet service, a wallet salt associated with the particular user/application combination. The wallet salt may be randomly generated by a wallet service 206 and may be used to decode and encode an encryption key, as explained more fully below. In particular embodiments, as explained below, wallet service 206 may provide wallet services (e.g., wallet creation, wallet management, etc.) to an application (such as for application developer 202), providing blockchain wallet integration with an application, as explained above. In particular embodiments, wallet service 206 may be hosted on a server computing device.

In particular embodiments, application developer 202 and wallet service 206 are hosted on separate computing devices (e.g., separate server devices). In particular embodiments, different entities may separately control one of the respective computing devices. Strict I/O controls and firewalls may be used to maintain security between these devices. For example, an application developer 202 may control one server device hosting application information and a different entity may control a server device hosting wallet service 206. As illustrated in FIG. 2 and explained more fully herein, wallet service 206 may not have access to user password 210, while application developer 202 may not have access to the information on wallet service 206 (e.g., to wallet salt 212 or encrypted wallet key 218). This architecture reduces the attack surface of the user's wallet key (i.e., private keys) necessary to access the user's blockchain assets. For example, simply hacking a server of application developer 202 may access the user's password 210, which is insufficient to gain access to the user's private key. Likewise, hacking wallet service 206 would at-most provide information that is insufficient to access the user's private keys. In fact, in the unlikely event that a hacker could gain access to both application developer 202 and wallet service 206 (which are physically separate, secured devices and may be operated and controlled by completely different entities), that would still be insufficient to gain access to the user's private keys, as explained more fully below.

Stateless key service 204 may be hosted on a computing device (e.g., a server) that is separate from either of the computing devices associated with application developer 202 and wallet service 206. In particular embodiments, a server hosting key service 204 may be operated by, or controlled by, either the application developer 202 or the entity that provides the wallet service 206, and a successful hack of that entity would still be insufficient to gain access to a user's private keys, at least because the other entity would still hold necessary information to generate those keys. Moreover, in particular embodiments, stateless key service 204 enforces strict input-output controls that severely limit an attacker's ability to gain access to that service. For example, key service 204 may not transmit data outside of key service 204, except in response to particular known, predetermined API calls. As another example, key service 204 may limit incoming connections to known computing devices.

Step 115 of the example method of FIG. 1 includes generating, by the stateless key service, an encryption key specific to the particular user/application combination, based on the user password, the wallet salt, and one or more first cryptographic techniques. The one or more first cryptographic techniques may include one or more of PBKDF2, HMAC, and SHA512, as illustrated in the example of FIG. 2. These cryptographic techniques, taking the wallet salt and user password as input, results in an encryption key 216.

Step 120 of the example method of FIG. 1 includes receiving, at the stateless key service and from the wallet service, an encrypted wallet key associated with the particular user/application combination. Step 125 of the example method of FIG. 1 includes generating, by the stateless key service, a wallet key specific to the particular user/application combination, based on the encrypted wallet key, the encryption key, and one or more second cryptographic technique. As illustrated in the example of FIG. 2, the second cryptographic techniques may include AES256 and/or GCM. Applying these techniques to encrypted wallet key 218 and encryption key 216, which was generated by key service 204, results in wallet key 222. As illustrated in FIG. 2, wallet key 222 can be used to sign a blockchain transaction. In other words, wallet key 222 is, or includes, the private key(s) necessary to perform the blockchain transaction requested by the user via the application.

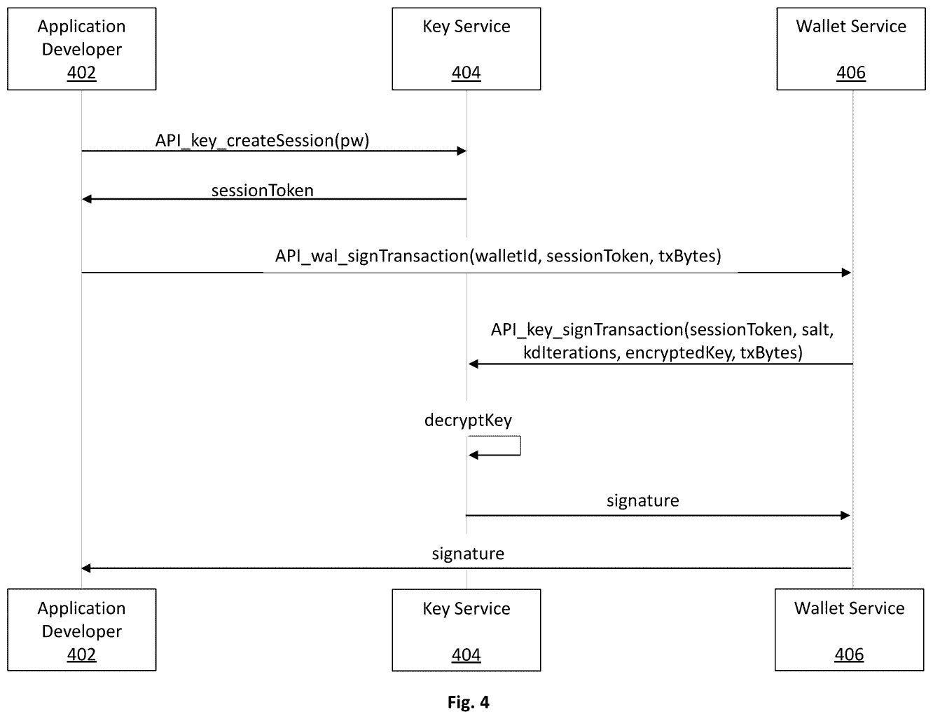

Step 130 of the example method of FIG. 1 includes signing, at the stateless key service, a blockchain transaction using the wallet key. FIG. 2 illustrates that signing transaction 226 may be based on transaction data 224 sent by the application, such as via application developer 202. Transaction data 224 identifies the transaction information that needs to be signed, approved, or otherwise validated using wallet key 222. In particular embodiments, for example as explained in connection with FIG. 4, transaction data may be sent from an application developer to a wallet service, which then forwards the transaction data to the key service. After signing the blockchain transaction (which as explained above may be a transaction to transfer assets, enter into an agreement, etc.), key service 204 may send signature 228 and/or the signed transaction data to an application developer 202. In particular embodiments, the signature and/or signed data may be sent to a wallet service, which forwards the information on the application developer.

While the example of FIG. 2 refers to certain information as coming from and being sent to an application developer 202, this disclosure contemplates that some or all of that data may be sent by or to a client device hosting the application.

As explained herein, the example method of FIG. 1 creates a secure, user-friendly architecture for managing private keys on the blockchain. For example, a user does not need to directly manage a wallet or manage their private keys, which as explained above, can be random, lengthy, unchangeable, and irrecoverable. In addition, the user does not need to distribute their private keys or store their private keys in multiple locations, thereby reducing security risks. Moreover, even though the architecture provides the user benefits of handing private-key management to a separate entity, the architecture reduces the attack surface from security risks such as hacks, because no stateful component (e.g., a server associated with an application developer or a server associated with a wallet service) holds any user's private keys, which exist only temporarily in the key service as needed to, e.g., sign blockchain transaction. Finally, as discussed herein, particular embodiments of the architecture described herein provide benefits to an application developer by securely integrating wallet functionality and offloading wallet management to a wallet service, thereby requiring the application developer to merely use a few API calls to implement wallet functionality.

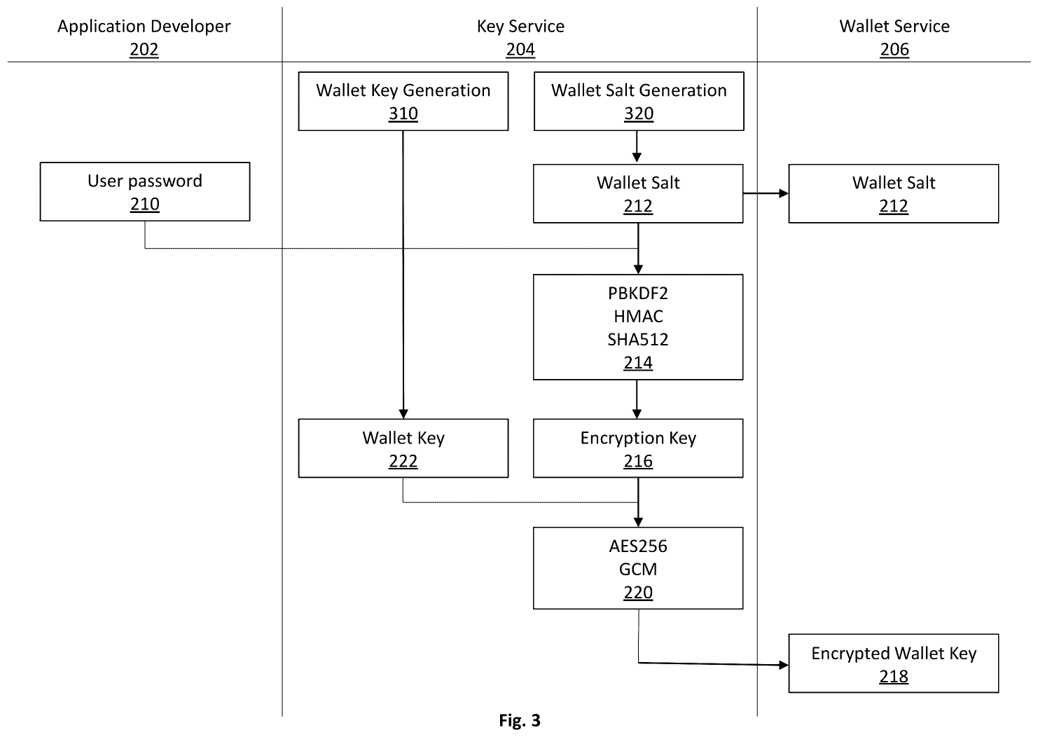

FIG. 3 illustrates an example architecture and implementation for creating an encrypted wallet key and a wallet salt, which in the examples of FIGS. 2 and 3 are stored in stateful wallet service 206. In the example of FIG. 3, key service 204 executes a wallet-key generation process 310 to create wallet key 222 for a particular user/application combination. As illustrated in this example, a wallet can generate a private key and a public key for a user, and those keys are associated with (e.g., managed by) that particular wallet and can be used for transaction on the blockchain associated with the wallet. In particular embodiments, a wallet may create and manage multiple private/public key pairs for a user.

Key service 320 also executes wallet-salt generation process 320 to create wallet salt 323, which is then transmitted by key service 204 to wallet service 206. As explained herein, key service 204 is stateless, and therefore wallet salt 212 is only temporarily stored in non-permanent memory of key service 204, making key service 204 a temporally unattractive target for hackers.

In the example of FIG. 3, key service 204 uses one or more first cryptographic techniques, such as techniques 214 to create an encryption key 216 from the wallet salt 212 and the user password 210 received from application developer 202 (or, in particular embodiments, from a client device hosting the application). Wallet key 222 and encryption key 216 created by key service 204 are used as inputs to create an encrypted wallet key 218, using second cryptographic techniques such as techniques 220. As illustrated in FIG. 3, encrypted wallet key 218 created by key service 204 is transmitted to wallet service 206, and as discussed herein, that key is not permanently stored by key service 204.

FIG. 4 illustrates an example flow diagram for an example implementation of the example method of FIG. 1. In FIG. 4, a user invokes a request that involves a wallet service (e.g., to sign a blockchain transaction during a process flow in the application). The user application transmits this request to application developer 402, which transmits an API call, e.g., “API_key_createSession (pw)” to key service 404. This is a known API call, which in particular embodiments, are the only inputs that will trigger responsive output from key service 404. After receiving the user password “pw” in the API call, key service 404 creates a session token, i.e., an authorization token, for the transaction, and transmits this token to application developer 402. Application developer 402 then transmits an API call “API_wal_signTransaction” to wallet service 406, and includes in the API call the session token, an identification of the user's wallet (walletId), and the relevant transaction information (txBytes). After receiving and validating this API call, wallet service 406 sends a known API call “API_key_signTransaction” to key service 404 and includes the session token, the user/application specific wallet salt (salt) and encrypted wallet key (encryptedKey) stored by the wallet service, the relevant transaction information, and the number of hash iterations used to derive the encryption key from the user password (kdIterations). After receiving this known API call and validating the call is authorized using the session token previously generated by the key service, key service 404 decrypts the wallet key (e.g., as described in connection with FIG. 2), signs the blockchain transaction, and transmits the required signature (which may be the signature itself, may include signed data, etc.) to wallet service 406. Wallet service 406 then transmits this signature back to application developer 402, which then replies to the waiting user application (e.g., by confirming that the requested transaction has been performed).

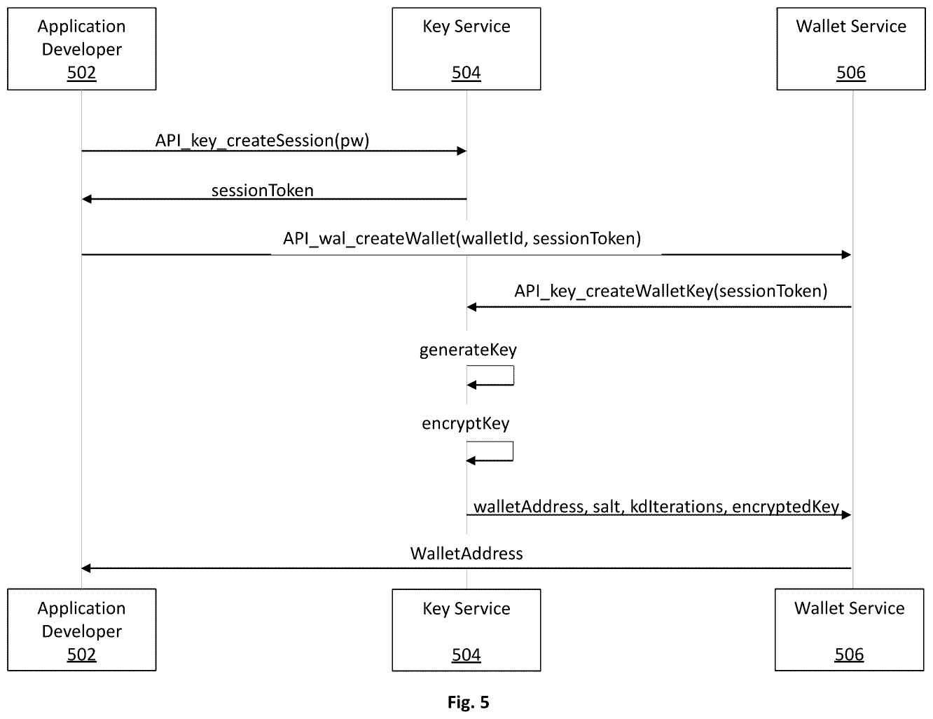

FIG. 5 illustrates an example flow diagram for creating a wallet on behalf of a user/application combination. As discussed herein and illustrated in the example of FIG. 5, in particular embodiments an application developer need only submit two API requests to integrate a secure wallet with their application experience, due to wallet service 506 and the overall architecture discussed herein. In the example of FIG. 5, application developer 502 submits an API_Key_createSession(pw) API call to key service 504, which responds to the known API call with a session token authenticating the session. Application developer 502 then submits an API_wal_createWallet API call, which includes the walletId and session token, to wallet service 506. Wallet service 506 submits a call API_key_createWalletKey, which includes the session token, to key service 504. Key service 504 then generates a wallet key and an encryption key, e.g., as illustrated in the example of FIG. 3. Key service 504 then transmits the wallet salt and encrypted wallet key to wallet service 506, as explained herein, and wallet service 506 transmits the wallet address to application developer 502.

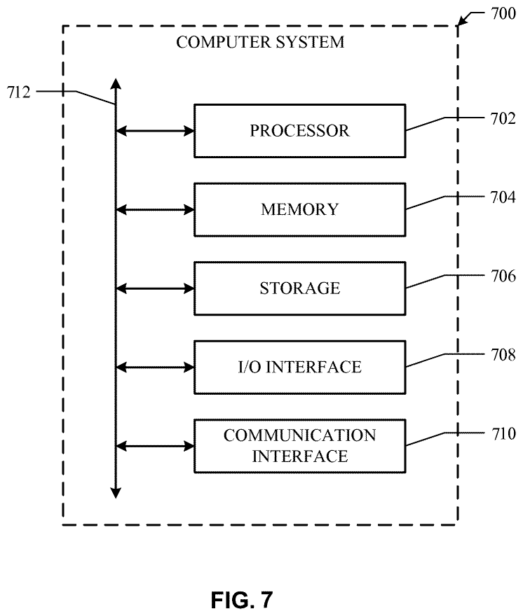

Particular embodiments may repeat one or more steps of the method of FIG. 1, where appropriate. Although this disclosure describes and illustrates particular steps of the method of FIG. 1 as occurring in a particular order, this disclosure contemplates any suitable steps of the method of FIG. 1 occurring in any suitable order. Moreover, although this disclosure describes and illustrates particular components, devices, or systems carrying out particular steps of the method of FIG. 1, such as the computer system of FIG. 7, this disclosure contemplates any suitable combination of any suitable components, devices, or systems carrying out any suitable steps of the method of FIG. 1. Moreover, this disclosure contemplates that some or all of the computing operations described herein, including the steps of the example method illustrated in FIG. 1, may be performed by circuitry of a computing device, for example the computing device of FIG. 7, by a processor coupled to non-transitory computer readable storage media, or any suitable combination thereof.

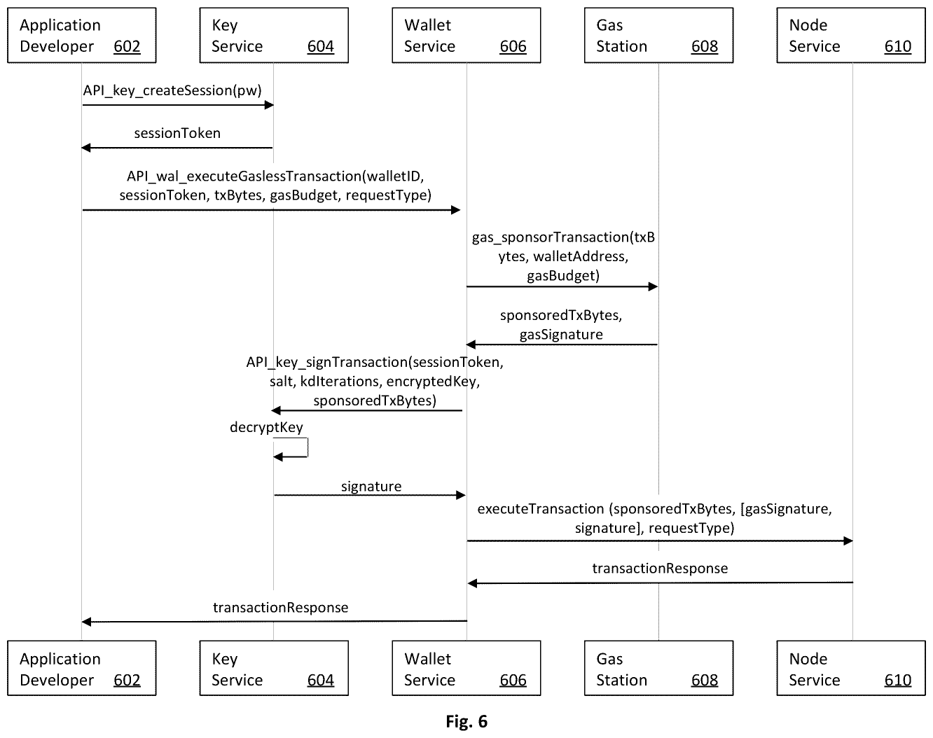

FIG. 6 illustrates an example implementation of an architecture that provides additional blockchain services to an application developer, specifically by executing a gasless blockchain transaction in connection with the developer's application. As illustrated in the example of FIG. 6, an application developer 602 may initiate a transaction by transmitting a user password to key service 604 to obtain a session token. Upon receipt of the token, application developer 602 may transmit to wallet service 606 an API call API_wal_executeGaslessTransaction, which includes the wallet ID, the session token, the relevant transaction data, the gas budget (gasBudget, beyond which value the transaction will not execute), and optional parameters such as requestType, which specifies an execution request type for the transaction. The wallet service then transmits a request gassponsorTransaction to gas station 608, which is a system that pays blockchain transaction fees on behalf of requesters, for example so that the requester does not need to hold or obtain cryptographic tokens native to the blockchain to pay the transaction fees.

If the necessary transaction fees to complete the application's requested blockchain transaction are less than the gasBudget value, then gas station 608 transmits a response with the sponsored transaction data (i.e., the transaction data with the necessary fee information sponsored by gas station 608) and the signature from gas station 608. Wallet service then makes an API call to key service 604 similar to that discussed above, except that the transaction information in this example is described in the sponsoredTxBytes variable. Key service 604 signs the transaction, as described herein, and transmits the required blockchain signature to wallet service 606. Wallet service 606 then transmits an executeTransaction call to node service 610, which is a node that maintains a copy of the blockchain ledger and executes transactions on the blockchain. Node service 610 executes the transaction and transmits a response to wallet service 606, which forwards the response to application developer 602. As illustrated in this example, an application developer is provided not only with wallet services and a secure private-key-management architecture discussed above, but also with blockchain transaction services (e.g., fee services, node services, etc.) based only on two simply API calls. In particular embodiments, two or more of wallet service 606, gas station 608, and node service 610 may be managed by, and/or provided by, a single entity.

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

1. A method comprising:
receiving, at a stateless key service and from an application associated with a particular user, a user password specific to a particular user/application combination;
receiving, at the stateless key service and from a wallet service, a wallet salt stored by the wallet service and associated with the particular user/application combination;
generating, by the stateless key service, an encryption key specific to the particular user/application combination, based on the user password, the wallet salt, and one or more first cryptographic techniques;
receiving, at the stateless key service and from the wallet service, an encrypted wallet key associated with the particular user/application combination, wherein the encrypted wallet key associated with the particular user/application combination is based on a combination of (1) the encryption key specific to the particular user/application combination and (2) a wallet key specific to the particular user/application combination and previously generated by the stateless key service;
generating, by the stateless key service, the wallet key specific to the particular user/application combination, based on the encrypted wallet key, the encryption key, and one or more second cryptographic techniques; and
signing, at the stateless key service, a blockchain transaction using the wallet key.

2. The method of claim 1, wherein the first cryptographic techniques comprise one or more of PBKDF2, HMAC, and SHA512.

3. The method of claim 1, wherein the second cryptographic techniques comprise one or more of AES256 or GCM.

4. The method of claim 1, further comprising:
receiving, at the stateless key service and from the wallet service, transaction data describing the blockchain transaction; and
sending, from the stateless key service to the wallet service, a signature corresponding to the signed blockchain transaction.

5. The method of claim 4, wherein the transaction data includes an identification that the transaction is sponsored by a gas station associated with the blockchain.

6. The method of claim 1, wherein the application is associated with a first computing device and the wallet service is associated with a second computing device.

7. The method of claim 6, wherein the first computing device is a first server and the second computing device is a second server.

8. The method of claim 6, wherein the stateless key service is associated with a third computing device.

9. The method of claim 8, wherein the first computing device is operated by a first entity and the second computing device is operated by a second entity.

10. The method of claim 9, wherein the third computing device is operated by the first entity or by the second entity.

11. The method of claim 1, wherein the stateless key service comprises a computing device comprising one or more processors coupled to one or more volatile computer-readable storage media, and the wallet key exists only in the volatile storage memory.

12. The method of claim 1, further comprising:
generating, by the stateless key service and in response to the received user password, a session token; and
transmitting, from the stateless key service to the application, the generated session token.

13. The method of claim 1, further comprising:
determining whether the password received from the application is part of a communication from the application that uses an API call known to the stateless key service; and
in response to a determination that the password received from the application is part of a communication from the application that uses an API call known to the stateless key service, then generating the encryption key.

14. One or more computer readable storage media storing instructions that, when executed by one or more processors coupled to the media, are operable to:
access, at a stateless key service and from an application associated with a particular user, a user password specific to a particular user/application combination;
access, at the stateless key service and from a wallet service, a wallet salt associated with the particular user/application combination;
generate, by the stateless key service, an encryption key specific to the particular user/application combination, based on the user password, the wallet salt, and one or more first cryptographic techniques;
access, at the stateless key service and from the wallet service, an encrypted wallet key associated with the particular user/application combination;
generate, by the stateless key service, a wallet key specific to the particular user/application combination, based on the encrypted wallet key, the encryption key, and one or more second cryptographic techniques; and
sign, at the stateless key service, a blockchain transaction using the wallet key.

15. A system comprising:
a first computing device comprising a first computer-readable storage media storing instructions and one or more first processors coupled to the first media, the one or more processors operable to execute the instructions to:
transmit, on behalf of an application, a user password specific to a particular user/application combination;
a third computing device comprising a third computer-readable storage media storing instructions and one or more second processors coupled to the third media, the one or more processors operable to execute the instructions to:
transmit, on behalf of a wallet service, a wallet salt associated with the particular user/application combination and an encrypted wallet key specific to the particular user/application combination; and
a second computing device comprising a second computer-readable storage media storing instructions and one or more second processors coupled to the second media, the one or more processors operable to execute the instructions to:
access the user password specific to a particular user/application combination;
access the wallet salt and the encrypted wallet key;
generate an encryption key specific to the particular user/application combination, based on the user password, the wallet salt, and one or more first cryptographic techniques;
generate a wallet key specific to the particular user/application combination, based on the encrypted wallet key, the encryption key, and one or more second cryptographic techniques; and
sign a blockchain transaction using the wallet key.

16. The system of claim 15, wherein the first cryptographic techniques comprise one or more of PBKDF2, HMAC, and SHA512.

17. The system of claim 15, wherein the second cryptographic techniques comprise one or more of AES256 or GCM.

18. The system of claim 15, wherein the first computing device comprises a first server, the second computing device comprises a second server, and the third computing device comprises a third server.

19. The system of claim 15, wherein the second computing device further comprises a volatile storage memory, and the second computing device is operable to generate the wallet key only in the volatile storage memory.

20. The system of claim 15, wherein the second computing device is operable to communicate with the first computing device or with the third computing device using only predetermined API calls.
